(19) United States
(12) Patent Application Publication
(10) Pub. No.: US 2011/0136665 A1
(43) Pub. Date: Jun. 9, 2011

(54) Ternary Fungicidal Mixtures

(76) Inventors: Jordi Tormo i Blasco, Laudenbach (DE); Thomas Grote, Wachenheim (DE); Maria Scherer, Godramstein (DE); Reinhard Stierl, Freinsheim (DE); Siegfried Strathmann, Limburgerhof (DE); Ulrich Schöfl, Bruhl (DE)

(21) Appl. No.: 10/591,290

(22) PCT Filed: Mar. 26, 2005
(86) PCT No.: PCT/EP2005/003213

§ 371 Date: Jun. 20, 2007

(30) Foreign Application Priority Data
Mar. 30, 2004 (DE) 102004016084.8

(51) Int. Cl. A01N 43/90; A01N 55/10; A01P 3/00; A01N 25/26

(52) U.S. Cl. 504/100; 514/259.31; 514/63

(57) ABSTRACT

Ternary fungicidal mixtures comprising, as active components,
1) the triazolopyrimidine derivative of the formula I, 5-chloro-7-(4-methylpiperidin-1-yl)-6-(2,4,6-trifluorophenyl)-[1,2,4]triazolo[1,5-a]pyrimidine
   and
2) a strobilurin derivative II, selected from among the compounds pyraclostrobin and orysastrobin
   and
3) a fungicidally active compound III selected from the group consisting of acylalanines, amine derivatives, anilinopyrimidines, antibiotics, azoles, dicarboximides, dithiocarbamates, copper fungicides, nitrophenyl derivatives, phenylpyrroles, sulfenic acid derivatives, cinnamides and analogs and anilazine, benomyl, boscalid, carbendazim, carboxin, oxycarboxin, cyazofamid, dazomet, dithianon, famoxadone, fenamidone, fenarimol, fuberidazole, flutolanil, furametpyr, isoprothiolane, mepronil, nuarimol, picobenzamid, probenazole, proquinazid, pyrifenox, pyroquilon, quinoxyfen, silthiofam, thiabendazole, thifluzamide, thiophanate-methyl, tiadinil, tricyclazole, triforine, sulfur, acibenzolar-S-methyl, benthiavalicarb, carpropamid, chlorothalonil, cyflufenamid, cymoxanil, dazomet, diclomezin, diclocymet, diethofencarb, edifenphos, ethaboxam, fenhexamid, fentin acetate, fenoxanil, ferimzone, fluazinam, phosphorous acid, fosetyl, fosetyl-aluminum, iprovalicarb, hexachlorobenzene, metrafenon, pencycuron, propamocarb, phthalide, toloclofos-methyl, quintozene and zoxamide;
   in a synergistically effective amount,
   methods for controlling phytopathogenic harmful fungi using mixtures of the compounds I and II and III with a fungicidally active compound III and the use of the compounds I and II with III for preparing such mixtures, and also compositions comprising these mixtures.

The present invention relates to ternary fungicidal mixtures comprising, as active components,

1) the triazolopyrimidine derivative of the formula I

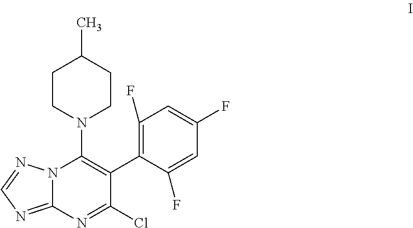

and
2) a strobilurin derivative II, selected from among the compounds

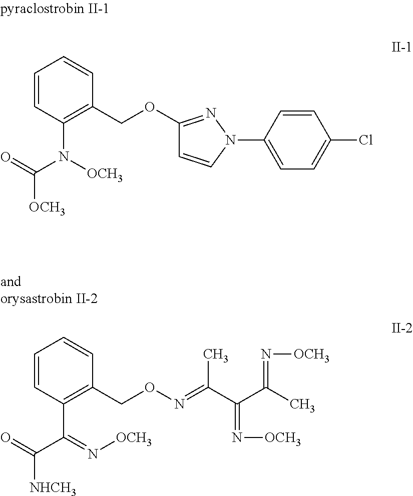

and
3) a fungicidally active compound III selected from the group consisting of acylalanines, amine derivatives, anilinopyrimidines, antibiotics, azoles, dicarboximides, dithiocarbamates, copper fungicides, nitrophenyl derivatives, phenylpyrroles, sulfenic acid derivatives, cinnamides and analogs and anilazine, benomyl, boscalid, carbendazim, carboxin, oxycarboxin, cyazofamid, dazomet, dithianon, famoxadone, fenamidone, fenarimol, fuberidazole, flutolanil, furametpyr, isoprothiolane, mepronil, nuarimol, picobenzamid, probenazole, proquinazid, pyrifenox, pyroquilon, quinoxyfen, silthiofam, thiabendazole, thifluzamide, thiophanate-methyl, tiadinil, tricyclazole, triforine, sulfur, acibenzolar-S-methyl, benthiavalicarb, carpropamid, chlorothalonil, cyflufenamid, cymoxanil, dazomet, diclomezin, diclocymet, diethofencarb, edifenphos, ethaboxam, fenhexamid, fentin acetate, fenoxanil, ferimzone, fluazinam, phosphorous acid, fosetyl, fosetyl-aluminum, iprovalicarb, hexachlorobenzene, metrafenon, pencycuron, propamocarb, phthalide, toloclofos-methyl, quintozene and zoxamide in a synergistically effective amount.

Moreover, the invention relates to a method for controlling phytopathogenic harmful fungi using mixtures of the compounds I and II and III with a fungicidally active compound III and to the use of the compounds I and II with III for preparing such mixtures, and to compositions comprising these mixtures.

The compound 1,5-chloro-7-(4-methylpiperidin-1-yl)-6-(2,4,6-trifluorophenyl)-[1,2,4]-triazolo[1,5-a]pyrimidine, its preparation and its action against harmful fungi are known from the literature (WO 98/46607).

The strobilurin derivatives II are also known in the literature (WO 96/01256; WO 97/15552). Mixtures of the strobilurin derivatives II with various other fungicidally active compounds have also been described in the literature.

Mixtures of the compound I with the strobilurin derivatives II-1 and II-2 are described in WO 04/045289 and WO 04/045283, respectively.

Mixtures of triazolopyrimidine derivatives with various fungicidally active compounds are proposed in a general manner in EP-A 988 790. The compound I is embraced by the general disclosure of this publication, but not explicitly mentioned. Mixtures of triazolopyrimidines with two further fungicidally active compounds are not proposed. Accordingly, the ternary mixtures are novel.

The synergistic mixtures, disclosed in EP-A 988 790, of triazolopyrimidines are described as being fungicidally active against various diseases of cereals, fruit and vegetables, in particular mildew on wheat and barley or gray mold on apples.

Practical agricultural experience has shown that the repeated and exclusive application of an individual active compound in the control of harmful fungi leads in many cases to a rapid selection of those fungus strains which have developed natural or adapted resistance against the active compound in question. Effective control of these fungi with the active compound in question is then no longer possible.

To reduce the risk of the selection of resistant fungus strains, mixtures of different active compounds are nowadays conventionally employed for controlling harmful fungi. By combining active compounds having different mechanisms of action, it is possible to ensure successful control over a relatively long period of time.

It is an object of the present invention to provide, with a view to effective resistance management and effective control of phytopathogenic harmful fungi, at application rates which are as low as possible, mixtures which, at a reduced total amount of active compounds applied, have improved activity against the harmful fungi (synergistic mixtures).

The mixtures defined at the outset have accordingly been found. Moreover, we have found that with simultaneous, that is joint or separate, application of the compounds I and II and one of the compounds III or successive application of the compound I and II and one of the compounds III, better control of harmful fungi can be achieved than is possible with the individual compounds.

The invention preferably provides mixtures of the compound I with pyraclostrobin II-1 and a compound III. They are particularly advantageous for controlling harmful fungi from the class of the Oomycetes.

The invention furthermore preferably provides mixtures of the compound I with orysastrobin II-2 and a compound III. They are particularly advantageous for controlling rice-pathogenic harmful fungi from the classes of the Ascomycetes, Deuteromycetes and Basidiomycetes.

In addition, the above-mentioned mixtures of the compounds I and Hand the compounds III or the simultaneous, that is joint or separate, use of the compounds I, II and a compound III are/is highly effective against a wide range of phytopathogenic fungi, in particular from the classes of the Ascomycetes, Deuteromycetes, Oomycetes and Basidiomycetes. Some of them act systemically and can be used in crop protection as foliar fungicides, as fungicides for seed dressing and as soil-acting fungicides.

They are particularly important for controlling a multitude of fungi on various cultivated plants, such as bananas, cotton, vegetable species (for example cucumbers, beans and cucurbits), barley, grass, oats, coffee, potatoes, corn, fruit species, rice, rye, soya, tomatoes, grapevines, wheat, ornamental plants, sugar cane and also on a large number of seeds.

They are particularly suitable for the control of the following phytopathogenic fungi: Blumeria graminis (powdery mildew) on cereals, Erysiphe cichoracearum and Sphaerotheca fuliginea on cucurbits, Podosphaera leucotricha on apples, Uncinula necator on grapevines, Puccinia species on cereals, Rhizoctonia species on cotton, rice and lawns, Ustilago species on cereals and sugar cane, Venturia inaequalis on apples, Bipolaris and Drechslera species on cereals, rice and lawns, Septoria species on wheat, Botrytis cinerea on strawberries, vegetables, ornamental plants and grapevines, Mycosphaerella species on bananas, peanuts and cereals, Pseudocercosporella herpotrichoides on wheat and barley, Pyricularia oryzae on rice, Phaksopora pachyrizi, and P. meibomiae on soya, Phytophthora infestans on potatoes and tomatoes, Pseudoperonospora species on cucurbits and hops, Plasmopara viticola on grapevines, Alternaria species on fruit and vegetables and also Fusarium and Verticillium species.

They can also be used in the protection of materials (e.g. the protection of wood), for example against Paecilomyces variotii.

The compounds I and II and the compounds III can be applied simultaneously, that is jointly or separately, or in succession, the sequence, in the case of separate application, generally not having any effect on the result of the control measures.

Suitable fungicidally active compounds III in the mixtures according to the invention are in particular fungicides selected from the following groups:
acylalanines, such as benalaxyl, metalaxyl, ofurace, oxadixyl,
amine derivatives, such as aldimorph, dodine, dodemorph, fenpropimorph, fen-propidin, guazatine, iminoctadine, spiroxamine, tridemorph,
anilinopyrimidines, such as pyrimethanil, mepanipyrim or cyprodinil,
antibiotics, such as cycloheximid, griseofulvin, kasugamycin, natamycin, polyoxin or streptomycin,
azoles, such as bitertanol, bromoconazole, cyproconazole, difenoconazole, dinitroconazole, enilconazole, epoxiconazole, fenbuconazole, fluquinconazole, flusilazole, flutriafol, hexaconazole, imazalil, ipconazole, metconazole, myclobutanil, penconazole, propiconazole, prochloraz, prothioconazole, simeconazole, tebuconazole, tetraconazole, triadimefon, triadimenol, triflumizol, triticonazole,
dicarboximides, such as iprodione, myclozolin, procymidone, vinclozolin,
dithiocarbamates, such as ferbam, nabam, maneb, mancozeb, metam, metiram, propineb, polycarbamate, thiram, ziram, zineb,
heterocyclic compounds, such as anilazine, benomyl, boscalid, carbendazim, car-boxin, oxycarboxin, cyazofamid, dazomet, dithianon, famoxadone, fenamidone, fenarimol, fuberidazole, flutolanil, furametpyr, isoprothiolane, mepronil, nuarimol, picobenzamid, probenazole, proquinazid, pyrifenox, pyroquilon, quinoxyfen, silthiofam, thiabendazole, thifluzamide, thiophanate-methyl, tiadinil, tricyclazole, triforine,
copper fungicides, such as Bordeaux mixture, copper acetate, copper oxychloride, basic copper sulfate,
nitrophenyl derivatives, such as binapacryl, dinocap, dinobuton, nitrophthalisopropyl,
phenylpyrroles, such as fenpiclonil or fludioxonil,
sulfur,
other fungicides, such as acibenzolar-S-methyl, benthiavalicarb, carpropamid, chlorothalonil, cyflufenamid, cymoxanil, diclomezin, diclocymet, diethofencarb, edifenphos, ethaboxam, fenhexamid, fentin acetate, fenoxanil, ferimzone, fluazinam, phosphorous acid, fosetyl, fosetyl-aluminum, iprovalicarb, hexachlorobenzene, metrafenone, pencycuron, penthiopyrad, propamocarb, phthalide, toloclofos-methyl, quintozene, zoxamid,
strobilurins, such as azoxystrobin, dimoxystrobin, enestroburin, fluoxastrobin, kresoxim-methyl, metominostrobin, orysastrobin, picoxystrobin, pyraclostrobin or trifloxystrobin,
sulfenic acid derivatives, such as captafol, captan, dichlofluanid, folpet, tolylfluanid,
cinnamides and analogous compounds, such as dimethomorph, flumetover or flu-morph.

The active compounds III mentioned above, their preparation and their action against harmful fungi are generally known (cf.: http://www.hclrss.demon.co.uk/index.html); they are commercially available:

benalaxyl, methyl N-(phenylacetyl)-N-(2,6-xylyl)-DL-alaninate (DE 29 03 612),
metalaxyl, methyl N-(methoxyacetyl)-N-(2,6-xylyl)-DL-alaninate (GB 15 00 581);
ofurace, (RS)-α-(2-chloro-N-2,6-xylylacetamido)-γ-butyrolactone [CAS RN 58810-48-3];
oxadixyl; N-(2,6-dimethylphenyl)-2-methoxy-N-(2-oxo-3-oxazolidinyl)acetamide (GB 20 58 059);
aldimorph, “4-alkyl-2,5(or 2,6)-dimethylmorpholine”, comprising 65-75% of 2,6-dimethylmorpholine and 25-35% of 2,5-dimethylmorpholine, comprising more than 85% of 4-dodecyl-2,5(or 2,6)-dimethylmorpholine, where “alkyl” also includes octyl, decyl, tetradecyl and hexadecyl, with a cis/trans ratio of 1:1 [CAS RN 91315-15-0];
dodine, 1-dodecylguanidinium acetate (Plant Dis. Rep., Vol. 41, p. 1029 (1957));
dodemorph, 4-cyclododecyl-2,6-dimethylmorpholine (DE 1198125);
fenpropimorph, (RS)-cis-4-[3-(4-tert-butylphenyl)-2-methylpropyl]-2,6-dimethyl-morpholine (DE 27 52 096);
fenpropidin, (RS)-1-[3-(4-tert-butylphenyl)-2-methylpropyl]piperidine (DE 27 52 096); guazatine, mixture of the reaction products from the amidation of technical grade iminodi(octamethylene)diamine, comprising various guanidines and polyamines [CAS RN 108173-90-6];
iminoctadine, 1,1′-iminodi(octamethylene)diguanidine (Congr. Plant Pathol., 1., p. 27 (1968);
spiroxamine, (8-tert-butyl-1,4-dioxaspiro[4.5]dec-2-yl)diethylamine (EP-A 281 842);
tridemorph, 2,6-dimethyl-4-tridecylmorpholine (DE 11 64 152);
pyrimethanil, 4,6-dimethylpyrimidin-2-ylphenylamine (DD-A 151 404);
mepanipyrim, (4-methyl-6-prop-1-ynylpyrimidin-2-yl)phenylamine (EP-A 224 339);
cyprodinil, (4-cyclopropyl-6-methylpyrimidin-2-yl)phenylamine (EP-A 310 550);
cycloheximid, 4-{(2R)-2-[(1S,3S,5S)-3,5-dimethyl-2-oxocyclohexyl]-2-hydroxyethyl}pi-peridine-2,6-dione [CAS RN 66-81-9];
griseofulvin, 7-chloro-2′,4,6-trimethoxy-6′-methylspiro[benzofuran-2(3H), 1′-cyclohex-2′-ene]-3,4′-dione [CAS RN 126-07-8];
kasugamycin, 3-O-[2-amino-4-[(carboxyiminomethyl)amino]-2,3,4,6-tetradeoxy-α-D-arabino-hexopyranosyl]-D-chiro-inositol [CAS RN 6980-18-3];
natamycin, (8E,14E,16E,18E,20E)-(1R,3S,5R,7R,12R,22R,24S,25R,26S)-22-(3-amino-3,6-dideoxy-β-D-mannopyranosyloxy)-1,3,26-trihydroxy-12-methyl-10-oxo-6,11,28-trioxatricyclo[22.3.1.0^{5,7}]octacosa-8,14,16,18,20-pentaene-25-carboxylic acid [CAS RN 7681-93-8];
polyoxin, 5-(2-amino-5-O-carbamoyl-2-deoxy-L-xylonamido)-1-(5-carboxy-1,2,3,4-tetrahydro-2,4-dioxopyrimidin-1-yl)-1,5-dideoxy-β-D-allofuranuronic acid [CAS RN 22976-86-9];
streptomycin, 1,1′-{1-L-(1,3,5/2,4,6)-4-[5-deoxy-2-O-(2-deoxy-2-methylamino-α-L-glucopyranosyl)-3-C-formyl-α-L-lyxofuranosyloxy]-2,5,6-trihydroxycyclohex-1,3-ylene}diguanidine (J. Am. Chem. Soc. Vol. 69, p. 1234 (1947));
bitertanol, β-([1,1′-biphenyl]-4-yloxy)-α-(1,1-dimethylethyl)-1H-1,2,4-triazole-1-ethanol (DE 23 24 020),
bromuconazole, 1-[[4-bromo-2-(2,4-dichlorophenyl)tetrahydro-2-furanyl]methyl]-1H-1,2,4-triazole (Proc. 1990 Br. Crop. Prot. Conf.—Pests Dis. Vol. 1, p. 459); cyproconazole, 2-(4-chlorophenyl)-3-cyclopropyl-1-[1,2,4]triazol-1-ylbutan-2-ol (U.S. Pat. No. 4,664,696);
difenoconazole, 1-{2-[2-chloro-4-(4-chlorophenoxy)phenyl]-4-methyl-[1,3]dioxolan-2-ylmethyl}-1H-[1,2,4]-triazole (GB-A 2 098 607);
diniconazole, (βE)-β-[(2,4-dichlorophenyl)methylene]-α-(1,1-dimethylethyl)-1H-1,2,4-triazole-1-ethanol (Noyaku Kagaku, 1983, Vol. 8, p. 575);
enilconazole (imazalil), 1-[2-(2,4-dichlorphenyl)-2-(2-propenyloxy)ethyl]-1H-imidazole (Fruits, 1973, Vol. 28, p. 545);
epoxiconazole, (2RS,3SR)-1-[3-(2-chlorophenyl)-2,3-epoxy-2-(4-fluorophenyl)propyl]-1H-1,2,4-triazole (EP-A 196 038);
fenbuconazole, α-[2-(4-chlorophenyl)ethyl]-α-phenyl-1H-1,2,4-triazole-1-propanenitrile (Proc. 1988 Br. Crop Prot. Conf.—Pests Dis. Vol. 1, p. 33);
fluquinconazole, 3-(2,4-dichlorophenyl)-6-fluoro-2-[1,2,4]-triazol-1-yl-3H-quinazolin-4-one (Proc. Br. Crop Prot. Conf.—Pests Dis., 5-3, 411 (1992));
flusilazole, 1-{[bis-(4-fluorophenyl)methylsilanyl]methyl}-1H-[1,2,4]triazole (Proc. Br. Crop Prot. Conf.—Pests Dis., 1, 413 (1984));
flutriafol, α-(2-fluorophenyl)-α-(4-fluorophenyl)-1H-1,2,4-triazole-1-ethanol (EP 15 756);
hexaconazole, 2-(2,4-dichlorophenyl)-1-[1,2,4]triazol-1-ylhexan-2-ol (CAS RN 79983-71-4);
ipconazole, 2-[(4-chlorophenyl)methyl]-5-(1-methylethyl)-1-(1H-1,2,4-triazol-1-yl-methyl)cyclopentanol (EP 267 778),
metconazole, 5-(4-chlorobenzyl)-2,2-dimethyl-1-[1,2,4]triazol-1-ylmethylcyclopentanol (GB 857 383);
myclobutanil, 2-(4-chlorophenyl)-2-[1,2,4]triazol-1-ylmethylpentanenitrile (CAS RN 88671-89-0);
penconazole, 1-[2-(2,4-dichlorophenyl)pentyl]-1H-[1,2,4]-triazole (Pesticide Manual, 12th Ed. (2000), S.712);
propiconazole, 1-[[2-(2,4-dichlorophenyl)-4-propyl-1,3-dioxolan-2-yl]methyl]-1H-1,2,4-triazole (BE 835 579);
prochloraz, N-(propyl-[2-(2,4,6-trichlorophenoxy)ethyl])imidazole-1-carboxamide (U.S. Pat. No. 3,991,071);
prothioconazole, 2-[2-(1-chlorocyclopropyl)-3-(2-chlorophenyl)-2-hydroxypropyl]-2,4-dihydro-[1,2,4]triazole-3-thione (WO 96/16048);
simeconazole, α-(4-fluorophenyl)-α-[(trimethylsilyl)methyl]-1H-1,2,4-triazole-1-ethanol [CAS RN 149508-90-7],
tebuconazole, 1-(4-chlorophenyl)-4,4-dimethyl-3-[1,2,4]triazol-1-ylmethylpentan-3-ol (EP-A 40 345);
tetraconazole, 1-[2-(2,4-dichlorophenyl)-3-(1,1,2,2-tetrafluoroethoxy)propyl]-1H-1,2,4-triazole (EP 234 242);
triadimefon, 1-(4-chlorophenoxy)-3,3-dimethyl-1-(1H-1,2,4-triazol-1-yl)-2-butanone (BE 793 867);
triadimenol, β-(4-chlorophenoxy)-α-(1,1-dimethylethyl)-1H-1,2,4-triazole-1-ethanol (DE 23 24 010);
triflumizol, (4-chloro-2-trifluormethylphenyl)-(2-propoxy-1-[1,2,4]triazol-1-ylethyliden)-amine (JP-A 79/119 462);
triticonazole, (5E)-5-[(4-chlorophenyl)methylene]-2,2-dimethyl-1-(1H-1,2,4-triazol-1-ylmethyl)cyclopentanol (FR 26 41 277);
iprodione, N-isopropyl-3-(3,5-dichlorophenyl)-2,4-dioxoimidazolidine-1-carboxamide (GB 13 12 536);
myclozolin, (RS)-3-(3,5-dichlorophenyl)-5-methoxymethyl-5-methyl-1,3-oxazolidine-2,4-dione [CAS RN 54864-61-8];
procymidone, N-(3,5-dichlorophenyl)-1,2-dimethylcyclopropane-1,2-dicarboximide (U.S. Pat. No. 3,903,090);
vinclozolin, 3-(3,5-dichlorophenyl)-5-methyl-5-vinyloxazolidine-2,4-dione (DE-A 22 07 576);
ferbam, iron(3+) dimethyldithiocarbamate (U.S. Pat. No. 1,972,961);
nabam, disodium ethylenebis(dithiocarbamate) (U.S. Pat. No. 2,317,765);
maneb, manganese ethylenebis(dithiocarbamate) (U.S. Pat. No. 2,504,404);
mancozeb, manganese ethylenebis(dithiocarbamate) polymer complex zinc salt (GB 996 264);
metam, methyldithiocarbaminic acid (U.S. Pat. No. 2,791,605);
metiram, zinc ammoniate ethylenebis(dithiocarbamate) (U.S. Pat. No. 3,248,400);
propineb, zinc propylenebis(dithiocarbamate) polymer (BE 611 960);
polycarbamate, bis(dimethylcarbamodithioato-κS,κS′)[μ-[[1,2-ethanediylbis[carbamodithioato-κS,κS′]](2-)]]di[zinc] [CAS RN 64440-88-6];
thiram, bis(dimethylthiocarbamoyl) disulfide (DE 642 532);
ziram, dimethyldithiocarbamate [CAS RN 137-30-4];
zineb, zinc ethylenebis(dithiocarbamate) (U.S. Pat. No. 2,457,674);
anilazine, 4,6-dichloro-N-(2-chlorophenyl)-1,3,5-triazine-2-amine (U.S. Pat. No. 2,720,480);
benomyl, N-butyl-2-acetylaminobenzoimidazole-1-carboxamide (U.S. Pat. No. 3,631,176);
boscalid, 2-chloro-N-(4′-chlorobiphenyl-2-yl)nicotinamide (EP-A 545 099);
carbendazim, methyl (1H-benzoimidazol-2-yl)carbamate (U.S. Pat. No. 3,657,443);
carboxin, 5,6-dihydro-2-methyl-N-phenyl-1,4-oxathiin-3-carboxamide (U.S. Pat. No. 3,249,499);
oxycarboxin, 5,6-dihydro-2-methyl-1,4-oxathiin-3-carboxanilide 4,4-dioxide (U.S. Pat. No. 3,399,214);
cyazofamid, 4-chloro-2-cyano-N,N-dimethyl-5-(4-methylphenyl)-1H-imidazole-1-sulfon-amide (CAS RN 120116-88-3];
dazomet, 3,5-dimethyl-1,3,5-thiadiazinane-2-thione (Bull. Soc. Chim. Fr. Vol. 15, p. 891 (1897));
dithianon, 5,10-dioxo-5,10-dihydronaphtho[2,3-b][1,4]dithiin-2,3-dicarbonitrile (GB 857 383);
famoxadone, (RS)-3-anilino-5-methyl-5-(4-phenoxyphenyl)-1,3-oxazolidine-2,4-dione [CAS RN 131807-57-3];
fenamidone, (S)-1-anilino-4-methyl-2-methylthio-4-phenylimidazolin-5-one [CAS RN 161326-34-7];
fenarimol, α-(2-chlorophenyl)-α-(4-chlorophenyl)-5-pyrimidinemethanol (GB 12 18 623);
fuberidazole, 2-(2-furanyl)-1H-benzimidazole (DE 12 09 799);
flutolanil, α,α,α-trifluoro-3′-isopropoxy-o-toluanilide (JP 1104514);
furametpyr, 5-chloro-N-(1,3-dihydro-1,1,3-trimethyl-4-isobenzofuranyl)-1,3-dimethyl-1H-pyrazole-4-carboxamide [CAS RN 123572-88-3];
isoprothiolane, diisopropyl 1,3-dithiolan-2-ylidenemalonate (Proc. Insectic. Fungic. Conf. 8. Vol. 2, p. 715 (1975));
mepronil, 3′-isopropoxy-o-toluanilide (U.S. Pat. No. 3,937,840);
nuarimol, α-(2-chlorophenyl)-α-(4-fluorophenyl)-5-pyrimidinemethanol (GB 12 18 623);
fluopicolide (picobenzamid), 2,6-dichloro-N-(3-chloro-5-trifluoromethylpyridin-2-ylmethyl)benzamide (WO 99/42447);
probenazole, 3-allyloxy-1,2-benzothiazole 1,1-dioxide (Agric. Biol. Chem. Vol. 37, p. 737 (1973));
proquinazid, 6-iodo-2-propoxy-3-propylquinazolin-4(3H)-one (WO 97/48684);
pyrifenox, 2′,4′-dichloro-2-(3-pyridyl)acetophenone (EZ)-O-methyloxime (EP 49 854);
pyroquilon, 1,2,5,6-tetrahydropyrrolo[3,2,1-ij]quinolin-4-one (GB 139 43 373)
quinoxyfen, 5,7-dichloro-4-(4-fluorophenoxy)quinoline (U.S. Pat. No. 5,240,940);
silthiofam, N-allyl-4,5-dimethyl-2-(trimethylsilyl)thiophene-3-carboxamide [CAS RN 175217-20-6];
thiabendazole, 2-(1,3-thiazol-4-yl)benzimidazole (U.S. Pat. No. 3,017,415);
thifluzamide, 2′,6′-dibromo-2-methyl-4′-trifluormethoxy-4-trifluormethyl-1,3-thiazole-5-carboxanilide [CAS RN 130000-40-7];
thiophanate-methyl, 1,2-phenylenebis(iminocarbonothioyl)bis(dimethylcarbamate) (DE-A 19 30 540);
tiadinil, 3′-chloro-4,4′-dimethyl-1,2,3-thiadiazole-5-carboxanilide [CAS RN 223580-51-6];
tricyclazole, 5-methyl-1,2,4-triazolo[3,4-b][1,3]benzothiazole [CAS RN 41814-78-2]; triforine, N,N′-{piperazine-1,4-diylbis[(trichlormethyl)methylene]}diformamide (DE 19 01 421);
Bordeaux mixture, mixture of CuSO₄×3Cu(OH)₂×3CaSO₄ [CAS RN 8011-63-0]
copper acetate, Cu(OCOCH₃)₂ [CAS RN 8011-63-0];
copper oxychloride, Cu₂Cl(OH)₃ [CAS RN 1332-40-7];
basic copper sulfate, CuSO₄ [CAS RN 1344-73-6];
binapacryl, (RS)-2-sec-butyl-4,6-dinitrophenyl 3-methylcrotonate [CAS RN 485-31-4];
dinocap, the mixture of 2,6-dinitro-4-octylphenylcrotonate and 2,4-dinitro-6-octyl-phenylcrotonate, where “octyl” is a mixture of 1-methylheptyl, 1-ethylhexyl and 1-propylpentyl (U.S. Pat. No. 2,526,660);
dinobuton, (RS)-2-sec-butyl-4,6-dinitrophenyl isopropyl carbonate [CAS RN 973-21-7];
nitrothal-isopropyl, diisopropyl 5-nitroisophthalate (Proc. Br. Insectic. Fungic. Conf. 7., Vol. 2, p. 673 (1973));
fenpiclonil, 4-(2,3-dichlorophenyl)-1H-pyrrole-3-carbonitrile (Proc. 1988 Br. Crop Prot. Conf.—Pests Dis., Vol. 1, p. 65);
fludioxonil, 4-(2,2-difluorobenzo[1,3]dioxol-4-yl)-1H-pyrrole-3-carbonitrile (The Pesticide Manual, publ. The British Crop Protection Council, 10th ed. (1995), p. 482);
acibenzolar-S-methyl, methyl 1,2,3-benzothiadiazol-7-carbothioate [CAS RN 135158-54-2];
flubenthiavalicarb (benthiavalicarb), isopropyl {(S)-1-[(1R)-1-(6-fluorobenzothiazol-2-yl)-ethylcarbamoyl]-2-methylpropyl}carbamate (JP-A 09/323,984);
carpropamid, 2,2-dichloro-N-[1-(4-chlorphenyl)ethyl]-1-ethyl-3-methylcyclopropane-carboxamide [CAS RN 104030-54-8];
chlorothalonil, 2,4,5,6-tetrachloroisophthalonitrile (U.S. Pat. No. 3,290,353);
cyflufenamid, (Z)-N-[α-(cyclopropylmethoxyimino)-2,3-difluoro-6-(trifluoromethyl)benzyl]-2-phenylacetamide (WO 96/19442);
cymoxanil, 1-(2-cyano-2-methoxyiminoacetyl)-3-ethylurea (U.S. Pat. No. 3,957,847);
diclomezine, 6-(3,5-dichlorophenyl-p-tolyl)pyridazin-3(2H)-one (U.S. Pat. No. 4,052,395)
diclocymet, (RS)-2-cyano-N-[(R)-1-(2,4-dichlorophenyl)ethyl]-3,3-dimethylbutyramide [CAS RN 139920-32-4];
diethofencarb, isopropyl 3,4-diethoxycarbanilate (EP 78 663);
edifenphos, O-ethyl S,S-diphenyl phosphorodithioate (DE 14 93 736)
ethaboxam, N-(cyano-2-thienylmethyl)-4-ethyl-2-(ethylamino)-5-thiazolecarboxamide (EP-A 639 574);
fenhexamid, N-(2,3-dichloro-4-hydroxyphenyl)-1-methylcyclohexanecarboxamide (Proc. Br. Crop Prot. Conf.—Pests Dis., 1998, Vol. 2, p. 327);
fentin acetate, triphenyltin (U.S. Pat. No. 3,499,086);
fenoxanil, N-(1-cyano-1,2-dimethylpropyl)-2-(2,4-dichlorophenoxy)propanamide (EP 262 393);
ferimzone, (Z)-2′-methylacetophenone-4,6-dimethylpyrimidin-2-ylhydrazone [CAS RN 89269-64-7];
fluazinam, 3-chloro-N-[3-chloro-2,6-dinitro-4-(trifluoromethyl)phenyl]-5-(trifluoromethyl)-2-pyridinamine (The Pesticide Manual, publ. The British Crop Protection Council, 10th ed. (1995), p. 474);
fosetyl, fosetyl-aluminum, ethylphosphonate (FR 22 54 276);
iprovalicarb, isopropyl [(1S)-2-methyl-1-(1-p-tolylethylcarbamoyl)propyl]carbamate (EP-A 472 996);
hexachlorbenzene (C. R. Seances Acad. Agric. Fr., Vol. 31, p. 24 (1945);
metrafenon, 3′-bromo-2,3,4,6′-tetramethoxy-2′,6-dimethylbenzophenone (U.S. Pat. No. 5 945 567);
pencycuron, 1-(4-chlorobenzyl)-1-cyclopentyl-3-phenylurea (DE 27 32 257);
penthiopyrad, (RS)-N-[2-(1,3-dimethylbutyl)-3-thienyl]-1-methyl-3-(trifluoromethyl)-1H-pyrazole-4-carboxamide (JP 10130268);
propamocarb, propyl 3-(dimethylamino)propylcarbamate (DE 15 67 169); phthalide (DE 16 43 347);
toloclofos-methyl, O-2,6-dichloro-p-tolyl O,O-dimethyl phosphorothioate (GB 14 67 561);
quintozene, pentachlornitrobenzene (DE 682 048);
zoxamide, (RS)-3,5-dichloro-N-(3-chloro-1-ethyl-1-methyl-2-oxopropyl)-p-toluamide [CAS RN 156052-68-5];
azoxystrobin, methyl 2-{2-[6-(2-cyano-1-vinylpenta-1,3-dienyloxy)pyrimidin-4-yloxy]phenyl}-3-methoxyacrylate (EP 382 375),
dimoxystrobin, (E)-2-(methoxyimino)-N-methyl-2-[α-(2,5-xylyloxy)-o-tolyl]acetamide (EP 477 631);
enestroburin, methyl 2-{2-[3-(4-chlorophenyl)-1-methylallylideneaminooxymethyl]-phenyl}-3-methoxyacrylate (EP 936 213);
fluoxastrobin, (E)-{2-[6-(2-chlorophenoxy)-5-fluoropyrimidin-4-yloxy]phenyl}(5,6-dihydro-1,4,2-dioxazin-3-yl)methanone O-methyloxime (WO 97/27189);
kresoxim-methyl, methyl (E)-methoxyimino[α-(o-tolyloxy)-o-tolyl]acetate (EP 253 213);
metominostrobin, (E)-2-(methoxyimino)-N-methyl-2-(2-phenoxyphenyl)acetamide (EP 398 692);
orysastrobin, (2E)-2-(methoxyimino)-2-{2-[(3E,5E,6E)-5-(methoxyimino)-4,6-dimethyl-2,8-dioxa-3,7-diazanona-3,6-dien-1-yl]phenyl}-N-methylacetamide (WO 97/15552);
picoxystrobin, methyl 3-methoxy-2-[2-(6-trifluoromethylpyridin-2-yloxymethyl)phenyl]-acrylate (EP 278 595);
pyraclostrobin, methyl N-{2-[1-(4-chlorophenyl)-1H-pyrazol-3-yloxymethyl]phenyl}(N-methoxy)carbamate (WO 96/01256);
trifloxystrobin, methyl (E)-methoxyimino-{(E)-α-[1-(α,α,α-trifluoro-m-tolyl)ethylidene-aminooxy]-o-tolyl}acetate (EP 460 575);
captafol, N-(1,1,2,2-tetrachloroethylthio)cyclohex-4-ene-1,2-dicarboximide (Phytopathology, Vol. 52, p. 754 (1962));
captan, N-(trichloromethylthio)cyclohex-4-ene-1,2-dicarboximide (U.S. Pat. No. 2,553,770); dichlofluanid, N-dichlorofluoromethylthio-N′,N′-dimethyl-N-phenylsulfamide (DE 11 93 498);
folpet, N-(trichlormethylthio)phthalimide (U.S. Pat. No. 2,553,770);
tolylfluanid, N-dichlorofluoromethylthio-N′,N′-dimethyl-N-p-tolylsulfamide (DE 11 93 498);
dimethomorph, 3-(4-chlorophenyl)-3-(3,4-dimethoxyphenyl)-1-morpholin-4-yl-propenone (EP 120 321);
flumetover, 2-(3,4-dimethoxyphenyl)-N-ethyl-α,α,α-trifluoro-N-methyl-p-toluamide [A-GROW no. 243, 22 (1995)];
flumorph, 3-(4-fluorophenyl)-3-(3,4-dimethoxyphenyl)-1-morpholin-4-ylpropenone (EP 860 438).

Preference is given to mixtures of the compounds I and II with an active compound III selected from the above-mentioned anilinopyrimidines, azoles, dithiocarbamates, heterocyclic compounds, sulfenic acid derivatives, cinnamic acid derivatives or the other fungicides mentioned, in particular the azoles mentioned.

Particular preference is given to mixtures of the compounds I and II with an active compound III selected from the group consisting of cyprodinil, epoxiconazole, fluquinconazole, metconazole, prochloraz, prothioconazole, tebuconazole, triticonazole, mancozeb, metiram, boscalid, dithianon, chlorothalonil, metrafenone, propamocarb, folpet and dimethomorph.

In one embodiment of the mixtures according to the invention, a further fungicide IV is added to the compounds II and III. Suitable components IV are the active compounds III mentioned above.

Mixtures of the compounds I and II with one component III are preferred.

The compounds I, II and III are usually applied in a weight ratio of from 100:1:5 to 1:100:20, preferably from 20:1:1 to 1:20:20 to 1:20:1 to 20:1:20, in particular from 10:1:1 to 1:10:10 to 1:10:1 to 10:1:10.

The components IV are, if desired, added in a ratio of from 20:1 to 1:20 to the mixtures of the compounds I, II and III.

Depending on the type of compound and the desired effect, the application rates of the mixtures according to the invention are from 5 g/ha to 2500 g/ha, preferably from 5 g/ha to 1000 g/ha, in particular from 50 to 750 g/ha.

Correspondingly, the application rates for the compound I are generally from 1 to 1000 g/ha, preferably from 10 to 900 g/ha, in particular from 20 to 750 g/ha.

Correspondingly, the application rates for the compounds II are generally from 1 to 1000 g/ha, preferably from 10 to 500 g/ha, in particular from 40 to 350 g/ha.

Correspondingly, the application rates for the compounds III are generally from 1 to 1000 g/ha, preferably from 10 to 500 g/ha, in particular from 40 to 350 g/ha.

In the treatment of seed, application rates of mixture are generally from 1 to 1000 g/100 kg of seed, preferably from 1 to 200 g/100 kg, in particular from 5 to 100 g/100 kg.

The method for controlling harmful fungi is carried out by the separate or joint application of the compounds I and II and a compound III or of the mixtures of the compounds I, II and a compound III, by spraying or dusting the seeds, the plants or the soil before or after sowing of the plants or before or after emergence of the plants.

The mixtures according to the invention, or the compounds I, II and III, can be converted into the customary formulations, for example solutions, emulsions, suspensions, dusts, powders, pastes and granules. The use form depends on the particular intended purpose; in each case, it should ensure a fine and even distribution of the compound according to the invention.

The formulations are prepared in a known manner, for example by extending the active compound with solvents and/or carriers, if desired using emulsifiers and dispersants. Solvents/auxiliaries suitable for this purpose are essentially:
water, aromatic solvents (for example Solvesso products, xylene), paraffins (for example mineral oil fractions), alcohols (for example methanol, butanol, pentanol, benzyl alcohol), ketones (for example cyclohexanone, gamma-butyrolactone), pyrrolidones (NMP, NOP), acetates (glycol diacetate), glycols, fatty acid dimethylamides, fatty acids and fatty acid esters. In principle, solvent mixtures may also be used.
carriers such as ground natural minerals (for example kaolins, clays, talc, chalk) and ground synthetic minerals (for example highly disperse silica, silicates); emulsifiers such as nonionogenic and anionic emulsifiers (for example polyoxyethylene fatty alcohol ethers, alkylsulfonates and arylsulfonates) and dispersants such as lignosulfite waste liquors and methylcellulose.

Suitable surfactants used are alkali metal, alkaline earth metal and ammonium salts of lignosulfonic acid, naphthalenesulfonic acid, phenolsulfonic acid, dibutylnaphthalene-]sulfonic acid, alkylarylsulfonates, alkyl sulfates, alkylsulfonates, fatty alcohol sulfates, fatty acids and sulfated fatty alcohol glycol ethers, furthermore condensates of sulfonated naphthalene and naphthalene derivatives with formaldehyde, condensates of naphthalene or of naphthalenesulfonic acid with phenol and formaldehyde, polyoxyethylene octylphenyl ether, ethoxylated isooctylphenol, octylphenol, nonylphenol, alkylphenyl polyglycol ethers, tributylphenyl polyglycol ether, tristearylphenyl polyglycol ether, alkylaryl polyether alcohols, alcohol and fatty alcohol ethylene oxide condensates, ethoxylated castor oil, polyoxyethylene alkyl ethers, ethoxylated polyoxypropylene, lauryl alcohol polyglycol ether acetal, sorbitol esters, lignosulfite waste liquors and methylcellulose.

Substances which are suitable for the preparation of directly sprayable solutions, emulsions, pastes or oil dispersions are mineral oil fractions of medium to high boiling point, such as kerosene or diesel oil, furthermore coal tar oils and oils of vegetable or animal origin, aliphatic, cyclic and aromatic hydrocarbons, for example toluene, xylene, paraffin, tetrahydronaphthalene, alkylated naphthalenes or their derivatives, methanol, ethanol, propanol, butanol, cyclohexanol, cyclohexanone, isophorone, highly polar solvents, for example dimethyl sulfoxide, N-methylpyrrolidone and water.

Powders, materials for spreading and dustable products can be prepared by mixing or concomitantly grinding the active substances with a solid carrier.

Granules, for example coated granules, impregnated granules and homogeneous granules, can be prepared by binding the active compounds to solid carriers. Examples of solid carriers are mineral earths such as silica gels, silicates, talc, kaolin, attaclay, limestone, lime, chalk, bole, loess, clay, dolomite, diatomaceous earth, calcium sulfate, magnesium sulfate, magnesium oxide, ground synthetic materials, fertilizers, such as, for example, ammonium sulfate, ammonium phosphate, ammonium nitrate, ureas, and products of vegetable origin, such as cereal meal, tree bark meal, wood meal and nutshell meal, cellulose powders and other solid carriers.

In general, the formulations comprise from 0.01 to 95% by weight, preferably from 0.1 to 90% by weight, of the active compounds. The active compounds are employed in a purity of from 90% to 100%, preferably 95% to 100% (according to NMR spectrum).

The following are examples of formulations: 1. Products for dilution with water

A) Water-soluble concentrates (SL)
10 parts by weight of the active compounds are dissolved in water or in a water-soluble solvent. As an alternative, wetters or other auxiliaries are added. The active compound dissolves upon dilution with water.
B) Dispersible concentrates (DC)
20 parts by weight of the active compounds are dissolved in cyclohexanone with addition of a dispersant, for example polyvinylpyrrolidone. Dilution with water gives a dispersion.
C) Emulsifiable concentrates (EC)
15 parts by weight of the active compounds are dissolved in xylene with addition of calcium dodecylbenzenesulfonate and castor oil ethoxylate (in each case 5% strength). Dilution with water gives an emulsion.

### D) Emulsions (EW, EO)

40 parts by weight of the active compounds are dissolved in xylene with addition of calcium dodecylbenzenesulfonate and castor oil ethoxylate (in each case 5% strength). This mixture is introduced into water by means of an emulsifying machine (Ultraturrax) and made into a homogeneous emulsion. Dilution with water gives an emulsion.

### E) Suspensions (SC, OD)

In an agitated ball mill, 20 parts by weight of the active compounds are comminuted with addition of dispersants, wetters and water or an organic solvent to give a fine active compound suspension. Dilution with water gives a stable suspension of the active compound.
F) Water-dispersible granules and water-soluble granules (WG, SG)
50 parts by weight of the active compounds are ground finely with addition of dispersants and wetters and prepared as water-dispersible or water-soluble granules by means of technical appliances (for example extrusion, spray tower, fluidized bed). Dilution with water gives a stable dispersion or solution of the active compound.
G) Water-dispersible powders and water-soluble powders (WP, SP)
75 parts by weight of the active compounds are ground in a rotor-stator mill with addition of dispersants, wetters and silica gel. Dilution with water gives a stable dispersion or solution of the active compound.
2. Products to be applied undiluted
H) Dustable powders (DP)
5 parts by weight of the active compounds are ground finely and mixed intimately with 95% of finely divided kaolin. This gives a dustable product.

### I) Granules (GR, FG, GG, MG)

0.5 part by weight of the active compounds is ground finely and associated with 95.5% carriers. Current methods are extrusion, spray-drying or the fluidized bed. This gives granules to be applied undiluted.
J) ULV solutions (UL)
10 parts by weight of the active compounds are dissolved in an organic solvent, for example xylene. This gives a product to be applied undiluted.

The active compounds can be used as such, in the form of their formulations or the use forms prepared therefrom, for example in the form of directly sprayable solutions, powders, suspensions or dispersions, emulsions, oil dispersions, pastes, dustable products, materials for spreading, or granules, by means of spraying, atomizing, dusting, spreading or pouring. The use forms depend entirely on the intended purposes; they are intended to ensure in each case the finest possible distribution of the active compounds according to the invention.

Aqueous use forms can be prepared from emulsion concentrates, pastes or wettable powders (sprayable powders, oil dispersions) by adding water. To prepare emulsions, pastes or oil dispersions, the substances, as such or dissolved in an oil or solvent, can be homogenized in water by means of a wetter, tackifier, dispersant or emulsifier.

However, it is also possible to prepare concentrates composed of active substance, wetter, tackifier, dispersant or emulsifier and, if appropriate, solvent or oil, and such concentrates are suitable for dilution with water.

The active compound concentrations in the ready-to-use preparations can be varied within relatively wide ranges. In general, they are from 0.0001 to 10%, preferably from 0.01 to 1%.

The active compounds may also be used successfully in the ultra-low-volume process (ULV), it being possible to apply formulations comprising over 95% by weight of active compound, or even to apply the active compound without additives.

Oils of various types, wetters, adjuvants, herbicides, fungicides, other pesticides, or bactericides may be added to the active compounds, even, if appropriate, not until immediately prior to use (tank mix). These agents are typically admixed with the compositions according to the invention in a weight ratio of from 1:10 to 10:1.

The compounds I and II or the mixtures or the corresponding formulations are applied by treating the harmful fungi, the plants, seeds, soils, areas, materials or spaces to be kept free from them with a fungicidally effective amount of the mixture or, in the case of separate application, of the compounds I and II. Application can be carried out before or after infection by the harmful fungi.

The fungicidal effect of the compound and the mixtures is demonstrated by the following tests:

The active compounds were prepared as a stock solution with 25 mg of active compound which was made up to 10 ml using a mixture of acetone and/or DMSO and the emulsifier Uniperol® EL (wetting agent having emulsifying and dispersing action based on ethoxylated alkylphenols) in a volume ratio of solvent/emulsifier of 99 to 1. The mixture was then made up with water to 100 ml. This stock solution was diluted with the solvent/emulsifier/water mixture described to the concentration of active compounds stated below.

### USE EXAMPLE 1

### Activity Against Net Blotch of Barley Caused by Pyrenophora teres, 1 Day Protective Application

Leaves of potted barley seedlings of the cultivar “Hanna” were sprayed to runoff point with an aqueous suspension having the concentration of active compound stated below. 24 hours after the spray coating had dried on, the test plants were inoculated with an aqueous spore suspension of Pyrenophora [syn. Drechslera] teres, the net blotch pathogen. The test plants were then placed in a greenhouse at temperatures between 20 and 24° C. and 95 to 100% relative atmospheric humidity. After 6 days, the extent of the development of the disease was determined visually in % infection of the entire leaf area.

The visually determined percentages of infected leaf areas were converted into efficacies in % of the untreated control:

The efficacy (E) is calculated as follows using Abbot's formula:

E=(1−α/β)·100
α corresponds to the fungicidal infection of the treated plants in % and
β corresponds to the fungicidal infection of the untreated (control) plants in %

An efficacy of 0 means that the infection level of the treated plants corresponds to that of the untreated control plants; an efficacy of 100 means that the treated plants were not infected.

The expected efficacies of mixtures of active compounds were determined using Colby's formula (Colby, S. R. “Calculating synergistic and antagonistic responses of herbicide combinations”, Weeds, 15, 20-22, 1967) and compared with the observed efficacies.

Colby's formula:

E=x+y−x·y/100
E expected efficacy, expressed in % of the untreated control, when using the mixture of the active compounds (I+II) and In at the concentrations a and b
x efficacy, expressed in % of the untreated control, when using the active compound combination (I+II) at the concentration a
y efficacy, expressed in % of the untreated control, when using the active compound III at the concentration b

TABLE A
Binary combination/individual active compounds

| | | Concentration of active | Efficacy in % |
|---|---|---|---|
| Exam- | Active compound/ | compound in the spray | of the |
| ple | mixing ratio | liquor [ppm] | untrated control |
| 1 | control | — | (90% infected) |
| | (untreated) | | |
| 2 | I + II.1 | 12.5 + 12.5 | 83 |
| | (1:1) | 6.25 + 6.25 | 67 |
| | | 3.1 + 3.1 | 56 |
| | | 1.6 + 1.6 | 44 |
| 3 | prochloraz | 25 | 0 |
| | | 12.5 | 0 |

TABLE B
Mixtures according to the invention

| | Active compound mixture | | |
|---|---|---|---|
| Exam- | concentration | Observed | Calculated efficacy |
| ple | mixing ratio | efficacy | *) |
| 4 | I + II.1 + prochloraz | 94 | 83 |
| | 12.5 + 12.5 + 25 ppm | | |
| | 1:1:2 | | |
| 5 | I + II.1 + prochloraz | 83 | 67 |
| | 6.25 + 6.25 + 12.5 ppm | | |
| | 1:1:2 | | |
| 6 | I + II.1 + prochloraz | 89 | 67 |
| | 6.25 + 6.25 + 25 ppm | | |
| | 1:1:4 | | |
| 7 | I + II.1 + prochloraz | 83 | 56 |
| | 3.1 + 3.1 + 12.5 ppm | | |
| | 1:1:4 | | |
| 8 | I + II.1 + prochloraz | 89 | 56 |
| | 3.1 + 3.1 + 25 ppm | | |
| | 1:1:8 | | |
| 9 | I + II.1 + prochloraz | 78 | 44 |
| | 1.6 + 1.6 + 12.5 ppm | | |
| | 1:1:8 | | |

*) efficacy calculated using Colby's formula

### USE EXAMPLE 2

### Activity Against Septoria nodorum Blotch of Wheat-Caused by Leptosphaeria nodorum

Pots with wheat plants of the cultivar “Kanzler” were sprayed to runoff point with an aqueous suspension having the concentration of active compound stated below. The next day, the pots were inoculated with an aqueous spore suspension of Leptosphaeria nodorum (syn. Stagonospora nodorum, Septoria nodorum). The plants were then placed in a chamber at 20° C. and maximum atmospheric humidity. After 8 days, the Septoria nodorum blotch on the untreated but infected control plants had developed to such an extent that the degree of infection could be determined visually in %.

Evaluation was carried out analogously to Example 1.

TABLE C
Binary combination/individual active compounds

| | | Concentration of active | Efficacy in % |
|---|---|---|---|
| Exam- | Active compound/ | compound in the spray | of the |
| ple | mixing ratio | liquor [ppm] | untrated control |
| 10 | control | — | (90% infected) |
| | (untreated) | | |
| 11 | I + II.1 | 1.6 + 1.6 | 44 |
| | (1:1) | | |
| 12 | boscalid | 12.5 | 33 |
| | | 3.1 | 11 |
| | | 1.6 | 0 |
| 13 | metconazole | 1.6 | 56 |
| | | 0.8 | 0 |
| | | 0.4 | 0 |
| 14 | epoxiconazole | 1.6 | 33 |
| | | 0.8 | 0 |
| | | 0.4 | 0 |

TABLE D
Mixtures according to the invention

| | Active compound mixture | | |
|---|---|---|---|
| Exam- | concentration | Observed | Calculated efficacy |
| ple | mixing ratio | efficacy | *) |
| 15 | I + II.1 + boscalid | 67 | 44 |
| | 1.6 + 1.6 + 1.6 ppm | | |
| | 1:1:1 | | |
| 16 | I + II.1 + boscalid | 78 | 51 |
| | 1.6 + 1.6 + 3.1 ppm | | |
| | 1:1:2 | | |
| 17 | I + II.1 + boscalid | 89 | 63 |
| | 1.6 + 1.6 + 12.5 ppm | | |
| | 1:1:8 | | |
| 18 | I + II.1 + metconazole | 89 | 75 |
| | 1.6 + 1.6 + 1.6 ppm | | |
| | 1:1:1 | | |
| 19 | I + II.1 + metconazole | 83 | 44 |
| | 1.6 + 1.6 + 0.8 ppm | | |
| | 2:2:1 | | |
| 20 | I + II.1 + metconazole | 56 | 11 |
| | 0.8 + 0.8 + 0.4 ppm | | |
| | 2:2:1 | | |
| 21 | I + II.1 + epoxiconazole | 94 | 63 |
| | 1.6 + 1.6 + 1.6 ppm | | |
| | 1:1:1 | | |
| 22 | I + II.1 + epoxiconazole | 89 | 44 |
| | 1.6 + 1.6 + 0.8 ppm | | |
| | 2:2:1 | | |
| 23 | I + II.1 + epoxiconazole | 33 | 11 |
| | 0.8 + 0.8 + 0.4 ppm | | |
| | 2:2:1 | | |

*) efficacy calculated using Colby's formula

### USE EXAMPLE 3

### Persistency Against Early Blight on Tomatoes Caused by Alternaria solani, 5 Day Protective Treatment

Leaves of potted plants were sprayed to runoff point with an aqueous suspension having the concentration of active compound stated below. To test for persistency, the leaves were infected with an aqueous spore suspension of Alternaria solani in a 2% strength biomalt solution having a density of 0.17×10⁶ spores/ml only after 5 days. The plants were then placed in a water-vapor-saturated chamber at temperatures between 20 and 22° C. After a further 5 days the disease on the treated but infected control plants had developed to such an extent that the infection could be determined visually in %.

Evaluation was carried out analogously to Example 1.

TABLE E
Binary combination/individual active compounds

| | | Concentration of active | Efficacy in % |
|---|---|---|---|
| Exam- | Active compound/ | compound in the spray | of the |
| ple | mixing ratio | liquor [ppm] | untrated control |
| 24 | control | — | (80% infected) |
| | (untreated) | | |
| 25 | I + II.1 | 12.5 + 12.5 | 25 |
| | (1:1) | 6.25 + 6.25 | 13 |
| | | 3.1 + 3.1 | 0 |
| 26 | I + II.2 | 25 + 25 | 13 |
| | (1:1) | | |
| 27 | boscalid | 6.25 | 0 |
| 28 | prochloraz | 25 | 0 |
| | | 12.5 | 0 |
| 29 | epoxiconazole | 25 | 0 |
| | | 6.25 | 0 |
| | | 3.1 | 0 |
| | | 1.6 | 0 |
| | | 0.8 | 0 |

TABLE F
Mixtures according to the invention

| | Active compound mixture | | |
|---|---|---|---|
| Exam- | concentration | Observed | Calculated efficacy |
| ple | mixing ratio | efficacy | *) |
| 30 | I + II.1 + boscalid | 96 | 13 |
| | 6.25 + 6.25 + 6.25 ppm | | |
| | 1:1:1 | | |
| 31 | I + II.1 + boscalid | 63 | 0 |
| | 3.1 + 3.1 + 6.25 ppm | | |
| | 1:1:2 | | |
| 32 | I + II.1 + epoxiconazole | 63 | 13 |
| | 6.25 + 6.25 + 6.25 ppm | | |
| | 1:1:1 | | |
| 33 | I + II.1 + epoxiconazole | 96 | 25 |
| | 12.5 + 12.5 + 3.1 ppm | | |
| | 4:4:1 | | |
| 34 | I + II.1 + epoxiconazole | 38 | 13 |
| | 6.25 + 6.25 + 1.6 ppm | | |
| | 4:4:1 | | |
| 35 | I + II.1 + epoxiconazole | 81 | 25 |
| | 12.5 + 12.5 + 1.6 ppm | | |
| | 8:8:1 | | |
| 36 | I + II.1 + epoxiconazole | 69 | 25 |
| | 12.5 + 12.5 + 0.8 ppm | | |
| | 16:16:1 | | |
| 37 | I + II.1 + prochloraz | 75 | 25 |
| | 12.5 + 12.5 + 12.5 ppm | | |
| | 1:1:1 | | |
| 48 | I + II.1 + prochloraz | 50 | 13 |
| | 6.25 + 6.25 + 12.5 ppm | | |
| | 1:1:2 | | |
| 39 | I + II.1 + prochloraz | 81 | 13 |
| | 6.25 + 6.25 + 25 ppm | | |
| | 1:1:4 | | |
| 40 | I + II.1 + prochloraz | 50 | 0 |
| | 3.1 + 3.1 + 25 ppm | | |
| | 1:1:8 | | |
| 41 | I + II.2 + epoxiconazole | 50 | 13 |
| | 25 + 25 + 25 ppm | | |
| | 1:1:1 | | |
| 42 | I + II.2 + epoxiconazole | 38 | 13 |
| | 25 + 25 + 6.25 ppm | | |
| | 4:4:1 | | |

*) efficacy calculated using Colby's formula

The test results show that, by virtue of the strong synergism, the mixtures according to the invention in all mixing ratios are considerably more active than had been predicted using Colby's formula.

1. A fungicidal mixture comprising
1) the triazolopyrimidine derivative of the formula I, 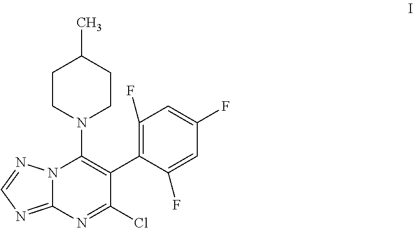
and
2) a strobilurin derivative II, selected from among the compounds 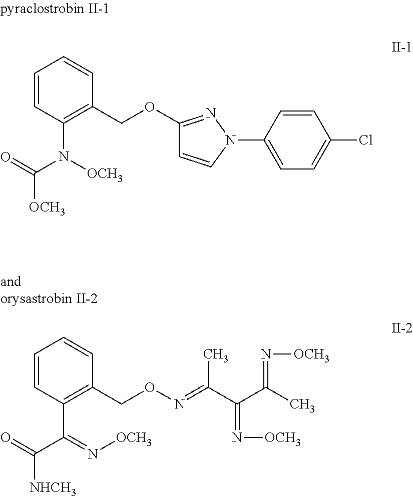
and
3) a fungicidally active compound III selected from the group of the azoles:
bitertanol, bromoconazole, cyproconazole, difenoconazole, dinitroconazole, enilconazole, epoxiconazole, fenbuconazole, fluquinconazole, flusilazole, flutriafol, hexaconazole, imazalil, ipconazole, metconazole, myclobutanil, penconazole, propiconazole, prochloraz, prothioconazole, simeconazole, tebuconazole, tetraconazole, triadimefon, triadimenol, triflumizole, triticonazole,
in a synergistically effective amount.

2. A fungicidal mixture comprising the compounds of the formulae I, II and III according to claim 1 in a weight ratio of from 100:1:5 to 1:100:20.

3. The fungicidal mixture according to claim 1 comprising, as strobilurin derivative II, pyraclostrobin II-1.

4. The fungicidal mixture according to claim 1 comprising, as strobilurin derivative II, orysastrobin II-2.

5. The fungicidal mixture according to claim 1, comprising, as fungicidally active compound III, a compound from the group consisting of epoxiconazole, metconazole and prochloraz.

6. A composition comprising a solid or liquid carrier and a mixture according to claim 1.

7. A method for controlling harmful fungi, which method comprises treating the fungi, their habitat or the seed, the soil or the plants to be protected against fungal attack with an effective amount of the mixture of compounds I, II and a compound III according to claim 1 or of the composition.

8. The method according to claim 7, wherein the compounds I, II and III are applied simultaneously, that is jointly or separately, or in succession.

9. The method according to claim 7, wherein the mixture or the composition is applied in an amount of from 5 g/ha to 2500 g/ha.

10. The method according to claim 7, wherein the mixture or the composition is applied in an amount of from 1 to 1000 g/100 kg of seed.

11. Seed comprising the mixture according to claim 1 in an amount of from 1 to 1000 g/100 kg.

12. The use of the compounds I, II and a compound III according to claim 1 for preparing a composition suitable for controlling harmful fungi.

13. The fungicidal mixture according to claim 2 comprising, as strobilurin derivative II, pyraclostrobin II-1.

14. The fungicidal mixture according to claim 2 comprising, as strobilurin derivative II, orysastrobin II-2.

15. The fungicidal mixture according to claim 2, comprising, as fungicidally active compound III, a compound from the group consisting of epoxiconazole, metconazole and prochloraz.

16. The fungicidal mixture according to claim 3, comprising, as fungicidally active compound III, a compound from the group consisting of epoxiconazole, metconazole and prochloraz.

17. The fungicidal mixture according to claim 4, comprising, as fungicidally active compound III, a compound from the group consisting of epoxiconazole, metconazole and prochloraz.

18. A composition comprising a solid or liquid carrier and a mixture according to claim 2.

19. A composition comprising a solid or liquid carrier and a mixture according to claim 3.

20. A composition comprising a solid or liquid carrier and a mixture according to claim 4.
